(19) United States
(12) Patent Application Publication
(10) Pub. No.: US 2013/0175125 A1
(43) Pub. Date: Jul. 11, 2013

(54) CONNECTION DEVICE BETWEEN FRICTION RING AND NAVE OF A BRAKE DISK

(71) Applicants: Kilian Förster, Hainsberg (DE); Christoph Saame, Gaimersheim (DE)

(72) Inventors: Kilian Förster, Hainsberg (DE); Christoph Saame, Gaimersheim (DE)

(73) Assignee: AUDI AG, Ingolstadt (DE)

(21) Appl. No.: 13/805,263

(22) PCT Filed: May 27, 2011
(86) PCT No.: PCT/EP2011/002643

§ 371 Date: Dec. 18, 2012

(30) Foreign Application Priority Data
Jun. 19, 2010 (DE) 10 2010 024 389.2

(51) Int. Cl. F16D 65/12; F16D 65/00

(52) U.S. Cl. CPC F16D 65/123; F16D 65/0043
USPC 188/218 XL; 29/428

(57) ABSTRACT

The invention relates to a connection device between a friction ring (2) and a support part (4) of a brake disk, with the friction ring (2) being connected by connecting members (12) to the friction ring (2), with several connecting members (12), which are disposed in spaced-apart relationship about the circumference of the support part (4) and connected with the support part (4), projecting into recesses in a radially inner circumferential wall of the friction ring (2), and with the bores (20) in the friction ring (2) and the connecting members (12) are configured conical, and with the conical bores (20) in the friction ring (2) expanding radially inwards and the conical connecting members (12) tapering radially outwards. In a method for constructing or producing the connection device, the bores (20) in the friction ring (2) and the connecting elements (12) are configured to be correspondingly conical.

The invention relates to a connection device between the friction ring and nave of a brake disk, with the friction ring being connected by connecting members to the friction ring, with several connecting members, which are disposed in spaced-apart relationship about the circumference of the support part and connected with the support part, projecting into recesses in a radially inner circumferential wall of the friction ring.

DE 43 32 951 A1 discloses a brake disk, in particular ventilated brake disk, having a friction ring and a support part connected with the friction ring by connecting members, wherein several connecting members in the form of pins, bolts or the like disposed in spaced-apart relationship about the circumference of the support part and connected with the support part project into recesses in a circumferential wall of the friction ring. The pins protrude radially from the peripheral wall of the support part and project into bores provided in the inner circumferential wall of the friction ring and located in the longitudinal center axis of the friction ring, with the pins being movable relative to the bores. The pins are arranged with little clearance in the bores.

In the pinned and tubular brake disks of DE 43 32 951 A1, the friction ring is connected by connecting members, such as pins, to the brake disk nave, with the bores and pins having a cylindrical configuration. As on one hand the operation demands very little clearance between the pins and the friction ring, and on the other hand depending on the material used the pins can have a greater coefficient of thermal expansion than the friction ring, and because the friction ring and the pins heat up during braking, both parts expand so that in case of poor tolerance conditions of the clearance the pins may get jammed in the friction ring. The process may be reversible or irreversible. Jamming of the pins can cause a change in the natural frequencies and damping properties of the disk, and the brake system that has been optimized to the original frequency level of the brake disk begins to squeak. In extreme cases, it can happen that the nave gets damaged and/or pins become loose. This can lead to a failure of the disk.

The invention is therefore based on the object, to provide a connection device between friction ring and support part of a brake disk with connecting members which are largely insensitive to temperature and allow realization of an optimized method for dimensioning and manufacture of the connection device.

The connection device according to the invention is characterized in that the bores in the friction ring and the connecting members have a conical configuration, with the conical bore in the friction ring expanding radially inwardly and the conical connecting members being tapered radially outwards.

During braking, friction ring and connecting members heat up and both parts expand. As a result, the friction ring expands radially outwards. As the connecting members and bores have a conical shape, jamming no longer occurs. Natural frequencies and damping properties of the disk do not change in any significant way in response to the change in temperature. The brake does not begin to squeak.

An advantageous embodiment of the connection device according to the invention is characterized in that the conicities of the connecting members on one hand, and the bores in the friction ring on the other hand, are so configured that the clearance between the friction ring and the connecting members remains essentially the same when the connecting members and the bores are caused to expand as a result of changes in temperature in the friction ring and the connecting members during operation. The connections slide reliably across all temperature ranges as the required clearance increases as a function of temperature. The nave can no longer be damaged and a loosening of the connecting members pins is prevented.

A further advantageous embodiment of the connection device is characterized in that the conicities of the connecting members on one hand and the bores in the friction ring on the other hand, are so configured that the coefficients of thermal expansion of the materials of the connecting members on one hand and the friction ring on the other hand, are taken into account.

To achieve the stated object, the method according to the invention for configuring a connection device is characterized in that the bores in the friction ring and the connecting members have conical configurations, with the conical bore in the friction ring expanding radially inwards and the conical connecting members being tapered radially outwards.

The technical implementation is easy to realize by advantageously modifying the bores and the connecting members, i.e. the pins or tubes. The mode of production of the brake disk is not altered. To produce the conical bores only the previously cylindrical tools for drilling and grinding of the bores are replaced by conical tools.

The conicities of the pins or tubes on one hand, and the bores in the friction ring on the other hand, are so configured that the expansion of the pins or tubes and the increase in the clearance of the bores as a result of changes in temperature in the friction ring and the pins offset one another. The original clearance is maintained in an advantageous manner and there is no jamming of the pins or tubes.

An advantageous embodiment of the method according to the invention is characterized in that the conicities of the connecting members on one hand, and the bores in the friction ring on the other hand, are so configured that the clearance between the friction ring and the connecting members remains substantially the same when the connecting members and the bores expand as a result of changes in temperature during operation in the friction ring and the connecting members.

A further advantageous embodiment of the method according to the invention is characterized in that the conicities of the connecting members on one hand, and the bores in the friction ring on the other hand, are configured such that the coefficients of thermal expansion of the materials of the connecting members on one hand and of the friction ring on the other hand are taken into account. This results in an advantageous manner in a greater flexibility when selecting the materials for the connecting members and the friction ring.

A further advantageous embodiment of the method according to the invention is characterized in that the conicity of the connecting members is realized when cold forming or mechanically machining, in particular grinding, the connecting members. The manufacturing process of the pin thus remains also unchanged. Depending on the angular disposition of the conicity, it is advantageously possible to provide the pin with a conical shape during cold forming or to produce the conical shape in the process later by grinding.

Further advantages, features and possible applications of the present invention will become apparent from the following description in conjunction with the exemplary embodiments illustrated in the drawings.

The description, the claims and the drawing use the terms used in the list of reference signs as listed below and associated reference signs. In the drawing:

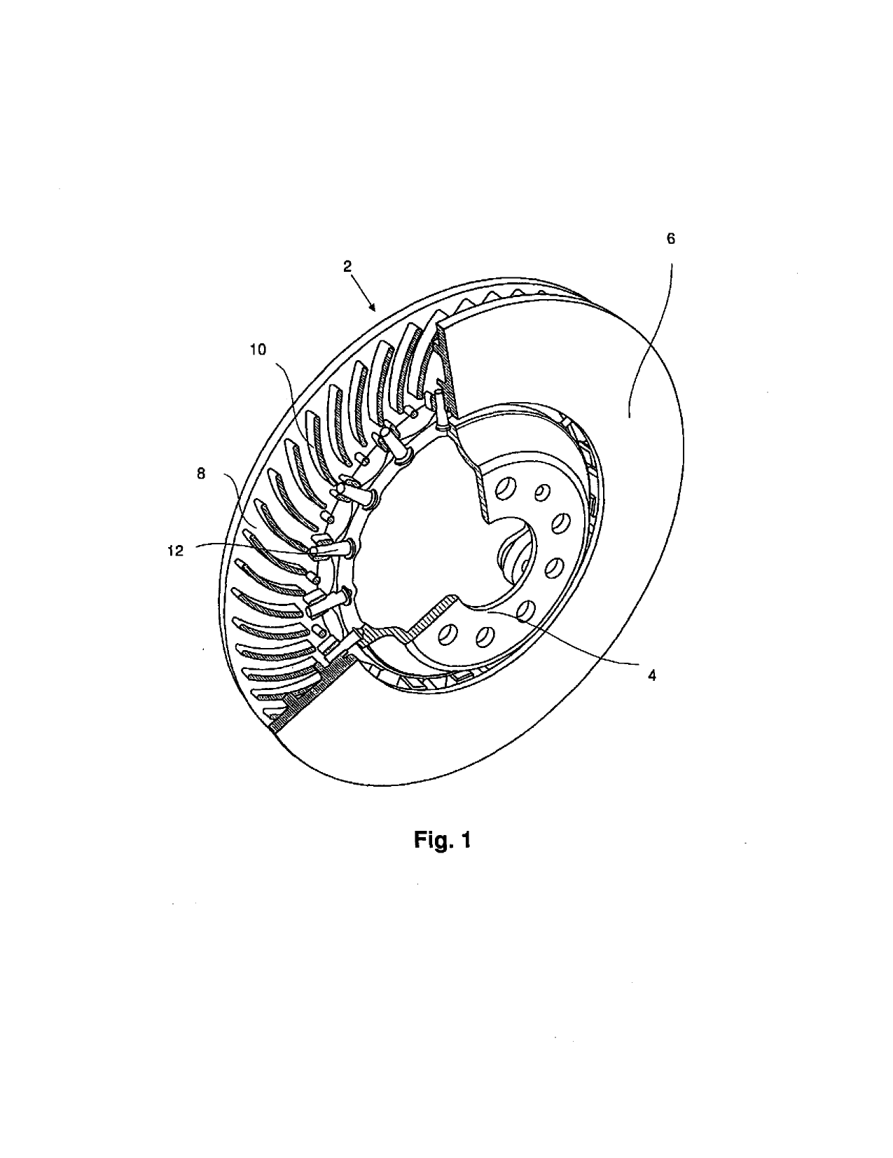

FIG. 1 shows a perspective, partially cutaway view of the brake disk with the friction ring and the support part;

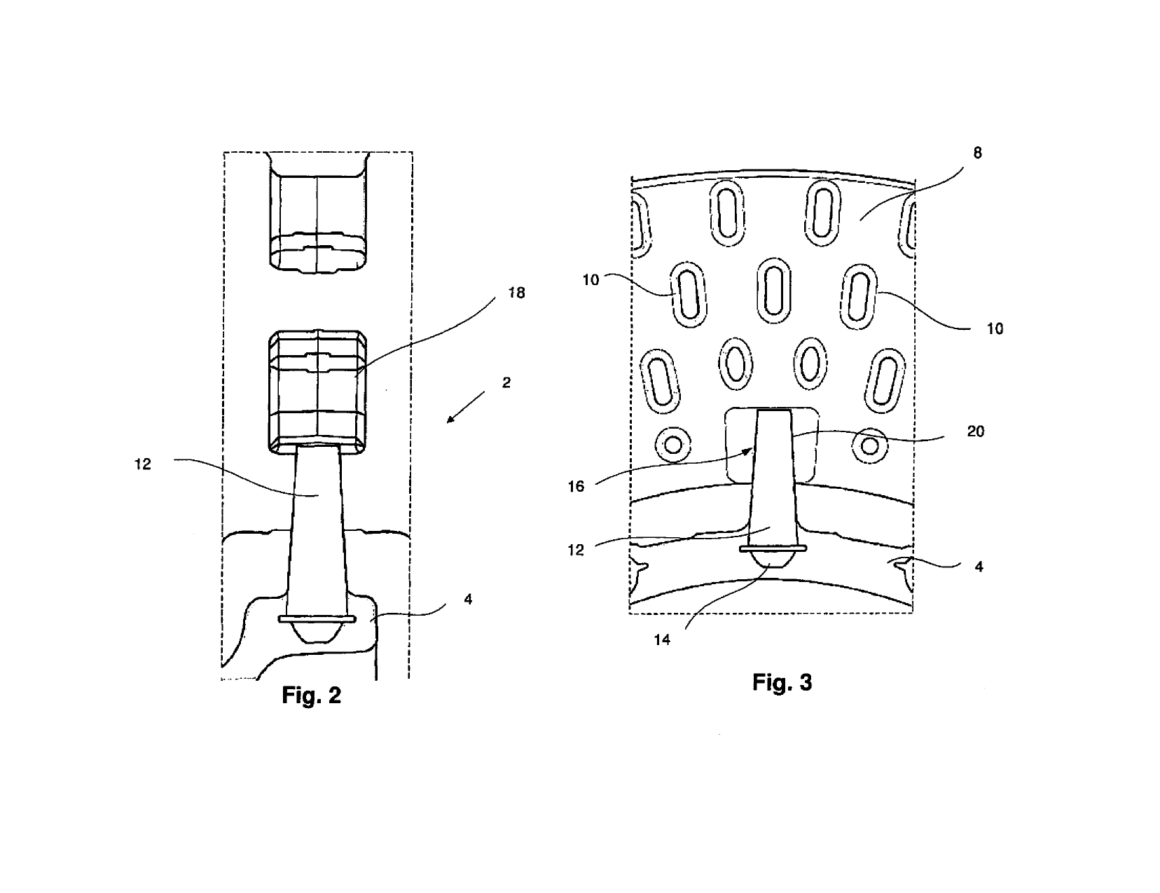

FIG. 2 shows a section through a friction ring and a support part of a brake disk in a radial plane perpendicular to the friction ring;

FIG. 3 shows a section through the friction ring and the support part of the brake disk according to FIG. 2 in a plane parallel to the friction ring, i.e. perpendicular to the section of FIG. 2.

The figures show by way of an exemplified embodiment of the connection device according to the invention for a brake disk with a friction ring and a support part 4 is shown. As can be seen from FIGS. 1 and 3, the friction ring 2 is comprised of two friction ring halves, with one friction ring half forming the outer wall 6 and the other friction ring half forming the inner wall 8 of the friction ring 2. The two friction ring halves are joined with one another by plates 10 which provide cooling of the brake disk during operation.

The connection device between the friction ring 2 and the support part 4 is formed by connecting members 12 which may be formed as pins or tubes. As a result, the friction ring 2 is floatingly mounted on the support part 4 so as to be able to expand in the radial direction when the temperature rises. Anchoring of the connecting members 12 in the support part 4 and mounting of the friction disk as a whole are realized in known manner as for example described in DE 43 32 951 A1.

The connecting members 12 at connected on one end 14 with the support part 6 or inserted therein or cast-in during casting of the support part. The other end 16 of the connecting members 12 is respectively received in a bushing 18 which is part of the friction ring 2.

As can be seen clearly from FIGS. 1 and 2, the connecting members 12 have a conical shape, and the bushings 18 have a correspondingly conical bore 20. The conical bores 20 in the bushings 18 of the friction ring 2 expand radially inwardly and the conical connecting members 12 taper radially outwards. The conicities of the connecting members 12 and the bores 20 in the bushings 18 of the friction ring 2 are configured such that the expansion of the connecting members 12 and the expansion of the bores 20 in the bushings 18 of the friction ring 2 offset one another as a result of a temperature change in the friction ring 2 and the connecting members 12 during operation. In general, the friction ring 2 expands radially outwards when undergoing a temperature increase during operation. On the other hand, the connecting member 12 expands radially outwards when undergoing a temperature increase, which is typically to be expected as a result of a transfer of heat from the friction ring 2. Thus, the bushing of the friction ring 2 with the bore and the radially outer end of the connecting member move in relation to one another so that the expanding connecting member 12 will bear upon a portion with increasing inner diameter of the bore 20, so that the bore 20 in the bushing 18 provides sufficient space to enable the connecting member 12 to expand radially without maintaining the clearance between the inner surface of the bore 20 and the outer surface of the connecting member 12.

As a result of the configuration in accordance with the invention of the conical bores 20 in the bushings 18 of the friction ring 2 and the conical shape of the connecting members 12, it is achieved in an advantageous manner that a greater range of materials is made available in conjunction with the selection of materials for the friction ring 2 and the support part 4, because each thermal expansion of the components can be compensated through use of different materials as a result of the corresponding conicity. In particular, when selecting the material for the connecting members, such an additional possibility of variation is advantageous.

### LIST OF REFERENCE SIGNS

2 friction ring
4 support part
6 outer wall
8 inner wall
10 plates
12 connecting member
14 an end of the connecting member
16 another end of the connecting member
18 bushing
20 bore

What is claimed is:

1.-8. (canceled)

9. A connection device between a friction ring and a support part of a brake disk, said connection device comprising connecting members disposed in spaced-apart relationship about a circumference of the support part and connected with the support part, said connecting members projecting into bores provided in a radially inner circumferential wall of the friction ring, said bores in the friction ring and said connecting members being configured conical, with the bores in the friction ring having a conicity expanding radially inwards and the connecting members having a conicity tapering radially outwards.

10. The connection device of claim 9, wherein the conicity of the connecting members and the conicity of the bores in the friction ring are so configured that a clearance between the friction ring and the connecting members remains essentially the same when the connecting members and the bores are caused to expand as a result of changes in temperature in the friction ring and the connecting members during operation.

11. The connection device of claim 9, wherein the conicity of the connecting members and the conicity of the bores in the friction ring are so configured that a coefficient of thermal expansion of a material of the connecting members and a coefficient of thermal expansion of a material of the friction ring are taken into account.

12. A method of providing a connection between a friction ring and a support part of a brake disk, comprising:
placing conical connecting members, having a conicity which tapers radially outwards, in spaced-apart relationship about a circumference of the support part;
securing the connecting members in the support part; and
engaging the connecting members in conical bores in a radially inner circumferential wall of the friction ring, with the conical bores having a conicity which expands radially inwards.

13. The method of claim 12, wherein the conicity of the connecting members and the conicity of the bores in the friction ring are so configured that a clearance between the friction ring and the connecting members remains essentially the same when the connecting members and the bores are caused to expand as a result of changes in temperature in the friction ring and the connecting members during operation.

14. The method of claim 12, wherein the conicity of the connecting members and the conicity of the bores in the friction ring are so configured that a coefficient of thermal expansion of a material of the connecting members and a coefficient of thermal expansion of a material of the friction ring are taken into account.

15. The method of claim 12, wherein the conicity of the connecting members is realized when cold forming the connecting members.

16. The method of claim 12, wherein the conicity of the connecting members is realized by mechanically machining of the connecting members.

17. The method of claim 12, wherein the conicity of the connecting members is realized by grinding of the connecting members.
